(19) United States
(12) Patent Application Publication
(10) Pub. No.: US 2015/0136387 A1
(43) Pub. Date: May 21, 2015

(54) FLUID EXCLUDER FOR LOGGING IN WATER BASED MUDS

(71) Applicants: Evan L. Davies, Spring, TX (US); Dustin R. Stubbs, Kingwood, TX (US); David O. Torres, Houston, TX (US)

(72) Inventors: Evan L. Davies, Spring, TX (US); Dustin R. Stubbs, Kingwood, TX (US); David O. Torres, Houston, TX (US)

(73) Assignee: Halliburton Energy Services, Inc., Houston, TX (US)

(21) Appl. No.: 14/404,096

(22) PCT Filed: Jun. 27, 2012
(86) PCT No.: PCT/US2012/044422

§ 371 Date: Nov. 26, 2014

(51) Int. Cl. E21B 49/00; E21B 47/01; E21B 49/08; G01V 3/26

(52) U.S. Cl. CPC E21B 49/005; G01V 3/26; E21B 47/01; E21B 49/087
USPC 166/250.01; 166/66

(57) ABSTRACT

A system and method for reducing borehole effects in a borehole within a subterranean formation is disclosed. The apparatus includes a fluid excluder, which includes a sleeve body and a sleeve opening defined by the sleeve body. The sleeve may be sized to fit around an induction tool. The sleeve body may include a fluid passageway therethrough, which may divert drilling fluids when the apparatus is deployed downhole. The apparatus may further include an electrode disposed within the fluid passageway for reducing the electrical current in the drilling fluid and thereby improve the readings obtained by logging devices.

### BACKGROUND

The present disclosure relates generally to well drilling operations and, more particularly, to logging equipment for well drilling and logging operations.

Existing well drilling operations require information on formation characteristics to aid in drilling decisions. Numerous measurement techniques are used, including logging while drilling (LWD), measuring while drilling (MWD), and wireline tests. One such measurement technique is resistivity logging, which works to characterize the rock or sediment in a borehole by measuring its electrical resistivity. Resistivity logging may be accomplished using induction tools, which typically use at least one electric coil in a downhole sonde to generate an alternating current loop in the formation by induction. The effectiveness of an induction tool, however is limited by downhole borehole effects. Borehole effects are typically caused by borehole fluids—including drilling muds—surrounding the induction tool, which conduct current and interfere with the resistivity measurements. The borehole effects are typically stronger in high saline environments, as the saline content increases the conductivity of the borehole fluid. What is needed is an apparatus that can reduce or eliminate the borehole effects to increase the effectiveness of downhole resistivity measurements.

### FIGURES

Some specific exemplary embodiments of the disclosure may be understood by referring, in part, to the following description and the accompanying drawings.

FIG. 1 illustrates a well with an existing wireline induction tool.

FIG. 2a illustrates an isometric view of an example fluid excluder according to aspects of the present disclosure.

FIG. 2b illustrates a front view of the example fluid excluder according to aspects of the present disclosure.

FIG. 2c illustrates a latitudinal cross-section of the example fluid excluder according to aspects of the present disclosure.

FIG. 3 illustrates an example logging apparatus deployed in a borehole, according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present disclosure relates generally to well drilling operations and, more particularly, to logging equipment for well drilling and logging operations.

Illustrative embodiments of the present disclosure are described in detail herein. In the interest of clarity, not all features of an actual implementation may be described in this specification. It will of course be appreciated that in the development of any such actual embodiment, numerous implementation-specific decisions must be made to achieve the specific implementation goals, which will vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the disclosure. Embodiments of the present disclosure may be applicable to horizontal, vertical, deviated, or otherwise nonlinear wellbores in any type of subterranean formation. Embodiments may be applicable to injection wells as well as production wells, including hydrocarbon wells. Devices and methods in accordance with certain embodiments may be used in one or more of wireline or slickline. Embodiments may be implemented in various formation tester tools suitable for testing, retrieval and sampling along sections of the formation that, for example, may be conveyed through flow passage in tubular string or using a wireline, slickline, coiled tubing, downhole robot or the like.

In this disclosure, a system and a method is proposed to reduce the borehole effects in a borehole within a subterranean formation. As will be discussed, the system may include an apparatus comprising a fluid excluder containing fluid passageways to divert drilling fluid around an induction tool, and electrodes enclosed within the fluid passageways to reduce electrical currents within the drilling fluid. The system and method described in the disclosure may effectuate a more accurate resistivity measurement by reducing or eliminating borehole effects while allowing fluid passageways around the tool, which may prevent the borehole from being swabbed while the measurements are being taken.

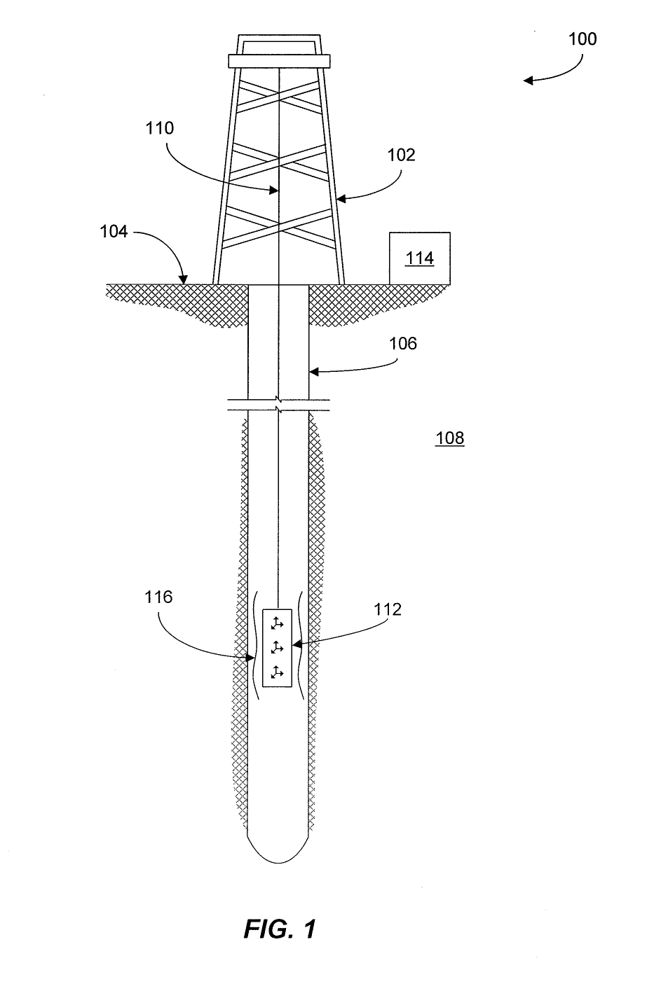

FIG. 1 shows an existing drilling system 100 that can be used for wireline logging operations. The drilling system 100 includes a rig 102 mounted at the surface 104, positioned above a borehole 106 within a subterranean formation 108. The rig 102 may be connected to a wireline 110, which may be coupled to and act as a communication medium for a downhole induction tool 112. In certain embodiments, the wireline may be communicably coupled to a control system 114 at the surface, which may collect measurements gathered by the induction tool 112. The measurements may include, for example, resistivity measurement of the formation 108.

The induction tool 112 may be positioned within the borehole 106 and surrounded by drilling fluid 116 within the borehole 106. In certain embodiments, the induction tool 112 may be used in a wireline logging system, in which a drill string is pulled out of the borehole 106 so that wireline logging tools may be introduced within the borehole 106. Drilling operations may include pumping drilling fluids 116 downhole to effectuate the drilling process, and the drilling fluid 112 may remain within the borehole once the drill string is removed. Drilling fluid 116 may include, for example, water based muds with varying salinity levels depending on the drilling application.

The induction tool 112 may comprise a downhole sonde that includes a plurality of antenna which transmit and receive electromagnetic (“EM”) energy into the formation 108. The antenna may be positioned according to the direction of their magnetic moments, to collect resistivity information in a plurality of pre-determined directions within the formation 108. One example induction tool 112 is a tri-axial induction tool, which may include three antennae, each positioned to measure resistivity characteristics along a different axis relative to the induction tool. Transmitting “EM” energy into the formation may excite an electrical current into the drilling fluid 116. The electrical current may also be generated by other logging tools located downhole. The excited electrical current, as well as other EM energy within the borehole 106 and drilling fluids are typically referred to collectively as borehole effects. The boreholes effects may interfere with both the transmission and receipt of EM energy from the formation 108, skewing the resistivity measurements. Unfortunately, removing the fluid entirely so that the electrical currents are not generated is problematic, as the drilling fluids and the pressure imparted to the formation 108 by the drilling fluid may be necessary to prevent fluids from within the formation 108 to escape into the borehole 106.

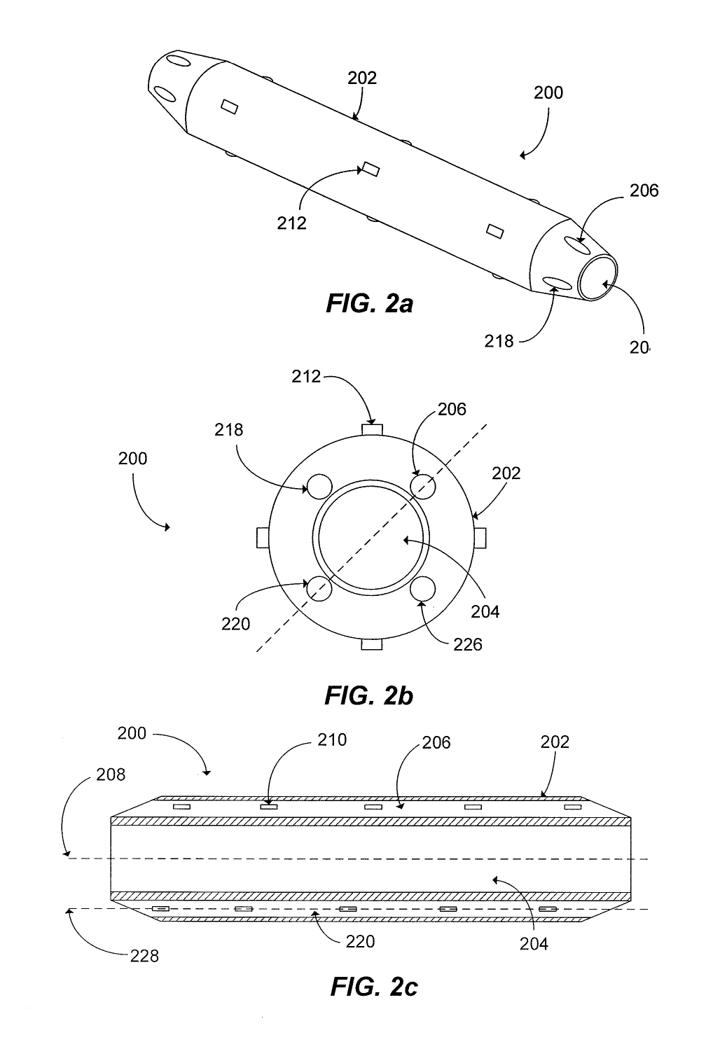

According to aspects of the present disclosure, FIGS. 2a-c illustrate an example apparatus, or fluid excluder, that can be installed around a downhole measurement tool and act to reduce the borehole effects without swabbing the borehole of fluid entirely. The fluid excluder 200 may be an elongated sleeve which includes a sleeve body 202 that defines a sleeve opening 204. The sleeve opening 204 may be sized to accommodate a logging tool, such as induction tool 112 from FIG. 1. In the embodiment shown, both the sleeve body 202 and the sleeve opening 204 comprise a generally cylindrical shape. Other shapes are possible for both the sleeve body 202 and sleeve opening 204, including cuboid, and, in certain embodiments, the sleeve body 202 and sleeve opening 204 may comprise different shapes.

The sleeve body 202 may include fluid passageways, such as fluid passageways 206, 218, 220 and 226 therethrough. The fluid passageway 206, for example, may divert fluid through the fluid excluder 200, and allow fluid to pass through the passageway 206 from one end of the fluid excluder 200 to the other. As can be seen, the fluid passageway 206 comprises a cylindrical port through the structure of the sleeve body 202, traveling the length of the fluid excluder 200. In certain embodiments, the fluid excluder 200 may include multiple fluid passageways, positioned radially around the sleeve body 202. The fluid excluder 200 may include a longitudinal axis 208, coaxial with the sleeve body 202 and the sleeve opening 204, and the fluid passageways may have longitudinal axes, such as axis 220 of passageway 218, that are parallel to the longitudinal axis 208 of the fluid excluder 200.

In certain embodiments, an electrode, such as electrode 210, may be disposed within a fluid passageways of the fluid excluder 200. In certain embodiment, there may be a plurality of electrodes in each fluid passageway of the fluid excluder, with each of the electrodes being positioned at a pre-determined location along the longitudinal axis 204 of the fluid excluder 200. In certain embodiments, the pre-determined locations may be determined, in part, based on the logging tool which will be installed. For example, when an induction tool is installed, the pre-determined locations of the electrodes may correspond to an electrical field generated by the induction tool, which may be characterized, in part, on the frequency and wavelength of the EM energy generated at the induction tool. In certain embodiments, the electrode 210, and all electrodes in the fluid excluder, may be connected to electrical ground, such that any electrical current within the drilling fluid flowing through the fluid passageways may be shorted out.

In certain embodiments, such as in FIGS. 2a-c, the sleeve body 202 may include at least one roller 212 disposed on an outer surface. The at least one roller 212 may contact the borehole wall when the fluid excluder 200 is introduced into a borehole, ensuring that the fluid excluder 200 will pass through the borehole without becoming stuck. In certain embodiments, the rollers may be spaced both laterally and radially around the sleeve body 202 such that the rollers, including roller 212, will make contact with the borehole wall. To further aide with the fluid excluder 200 passing effectively through a borehole, the sleeve body 202 may be constructed of either a rigid material, such as plastic or composite material, or a flexible material, such as a composite matrix, to conform to non-cylindrical boreholes.

FIG. 2c illustrates a cross section of the fluid excluder 200 taken along the dashed line in FIG. 2b. As can be seen, fluid passageway 220 includes a longitudinal axis 228. The longitudinal axis 228 may be parallel to the longitudinal axis 208 of the fluid excluder 200. In certain embodiments, each fluid passageway of a fluid excluder may have longitudinal axes that are parallel to one another and to the longitudinal axis 208 of the fluid excluder 200.

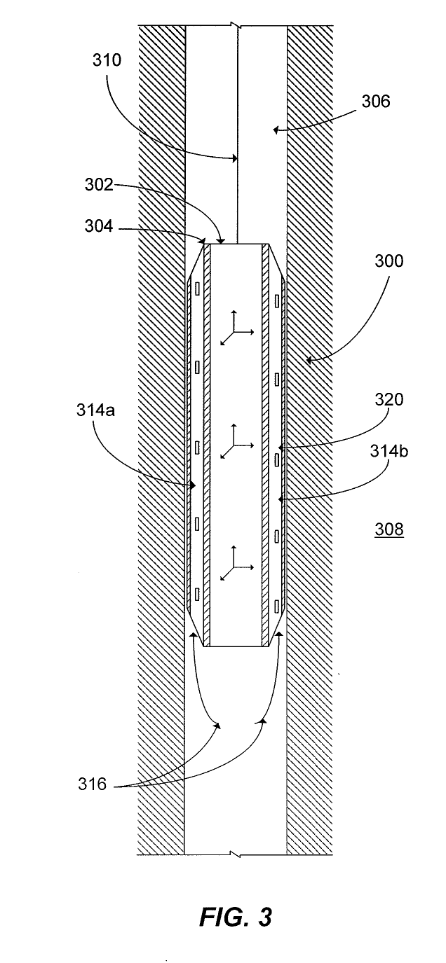

FIG. 3 illustrates and example logging apparatus 300, including an induction tool 302 installed within a fluid excluder 304, according to aspects of the present disclosure. As can be seen the apparatus is suspended in the borehole 306 within formation 308 on a wireline 310. As the apparatus 300 is positioned to a pre-determined location in the borehole 306, drilling fluid within the borehole 306 may be diverted into fluid passageways 314a and 314b within the fluid excluder 304, as indicated by arrows 316. As can be seen, the annular area between the induction tool 302 and the wall of the borehole 306 may be generally free of drilling fluids, except for the drilling fluid within the fluid passageways 314a and 314b. Electrical current within the drilling fluid surrounding the induction tool 302 may be reduced or eliminated using electrodes, such as electrode 320, positioned with fluid passageways 314a and 314b. In certain embodiments, the electrodes may be connected to an electrical ground through the induction tool 302, such that the electrical currents flowing through the drilling fluid is shorted out. As would be appreciated by one of ordinary skill in view of this disclosure, with the borehole effects generally reduced, the induction tool 302 can take a more accurate resistivity measurement of the formation 308. As would also be appreciated by one of ordinary skill in view of this disclosure, the apparatus is able to divert the drilling fluids and reduce the borehole effects without swabbing the borehole of drilling fluid, which may create problems as logging and drilling operations continue.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are defined herein to mean one or more than one of the element that it introduces.

What is claimed is:

1. An apparatus for reducing borehole effects in a borehole within a subterranean formation, comprising:
a sleeve body;
a sleeve opening defined by the sleeve body;
a fluid passageway through the sleeve body; and
an electrode disposed within the fluid passageway.

2. The apparatus of claim 1, further comprising a roller disposed on an outer surface of the sleeve body.

3. The apparatus of claim 1, wherein the fluid passageway is adapted to divert fluid through the apparatus when the apparatus is disposed in the borehole.

4. The apparatus of claim 1, wherein the sleeve opening is sized to accommodate an induction tool.

5. The apparatus of claim 4, wherein the electrode is positioned at a pre-determined location within the fluid passageway, wherein the pre-determined location corresponds to an electrical field generated by the induction tool.

6. The apparatus of claims 1, wherein the electrode is coupled to an electrical ground.

7. The apparatus of claim 1, wherein the sleeve body comprises a rigid material.

8. The apparatus of claim 1, wherein the sleeve body comprises a flexible material.

9. A method for reducing borehole effects in a borehole within a subterranean formation, comprising:
providing a fluid excluder, wherein the fluid excluder comprises:
a sleeve body and a sleeve opening defined by the sleeve body,
a fluid passageway through the sleeve body, and
an electrode disposed within the fluid passageway; and
inserting an induction tool within the sleeve opening of the fluid excluder;
positioning the fluid excluder within the borehole;
measuring a resistivity characteristic of the subterranean formation using the induction tool.

10. The method of claim 9, wherein measuring a resistivity characteristic of the subterranean formation includes:
diverting into the fluid passageway a drilling fluid located within the borehole, and
reducing an electrical current within the drilling fluid using the electrode.

11. The method of claim 9, wherein the fluid excluder further comprises a roller disposed on an outer surface of the sleeve body.

12. The method of claim 10, wherein the fluid passageway diverts fluid around the induction tool when the fluid excluder is disposed in the borehole.

13. The method of claim 10, wherein the sleeve opening is sized to accommodate the induction tool.

14. The method of claim 13, wherein the electrode is positioned at a pre-determined location within the fluid passageway, wherein the pre-determined location corresponds to an electrical field generated by the induction tool.

15. The method of claim 14, wherein the electrode is coupled to an electrical ground.

16. The method of claim 9, wherein the sleeve body comprises a rigid material.

17. The method of claim 9, wherein the sleeve body comprises a flexible material.

18. A method for reducing borehole effects in a borehole within a subterranean formation:
introducing an induction tool into the borehole, wherein the induction tool is installed within a fluid excluder;
diverting into a fluid passageway of the fluid excluder a drilling fluid located within the borehole, and
reducing an electrical current within the drilling fluid using an electrode positioned within the fluid passageway.

19. The method of claim 18, wherein the electrode is coupled to an electrical ground.

20. The method of claim 19, further comprising measuring a resistivity characteristic of the subterranean formation using the induction tool.
